(19) United States
(12) Patent Application Publication
(10) Pub. No.: US 2010/0006073 A1
(43) Pub. Date: Jan. 14, 2010

(54) Increasing effeciency of internal combustion engines to increase mileage of vehicles

(76) Inventor: Jayant Jatkar, Naperville, IL (US)

Correspondence Address: JAYANT JATKAR, 1335 HUNTER CIRCLE, NAPERVILLE, IL, 60540-8382, US

(21) Appl. No.: 12/217,921

(22) Filed: Jul. 10, 2008

(51) Int. Cl. F02G 5/00

(52) U.S. Cl. 123/556; 290/1 A

(57) ABSTRACT

Most of the cars in today's market give a maximum of 30 to 40 miles per gallon and hybrid cars giving upto 50 miles per gallon. The efficiency of Internal Combustion Engines used for this purpose is very low, about 25%. The heat generated during the combustion of fuel is converted into work to drive the car is wasted to the atmosphere, as anti-freeze(Ethylene Glycol) is used to cool the engine and circulated through a radiator which transfers the heat to the atmosphere. The heat generated by combustion of fuel such as gasoline or diesel is converted into the work because of the pressure created by the combustion process. In this invention, the heat is recovered by pre-heating/pressurizing the fresh air used for the process of combustion. The temperature of the pre-heated fresh air used for combustion is increased to above 1400 degrees Fahrenheit by passing through a heat exchanger to recover heat from combustible gases.

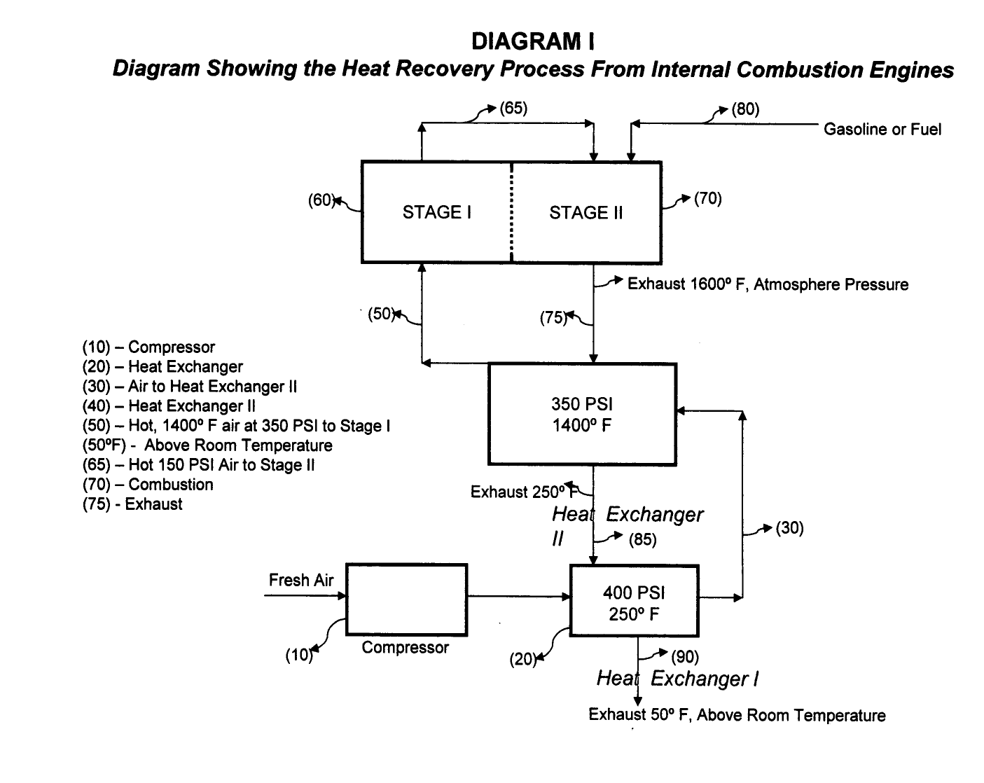

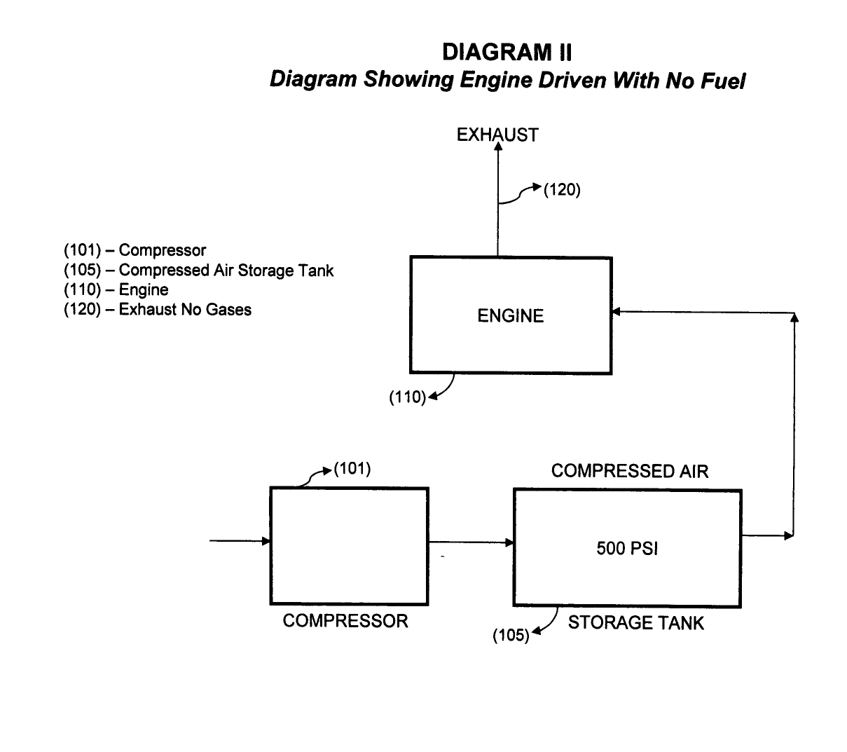

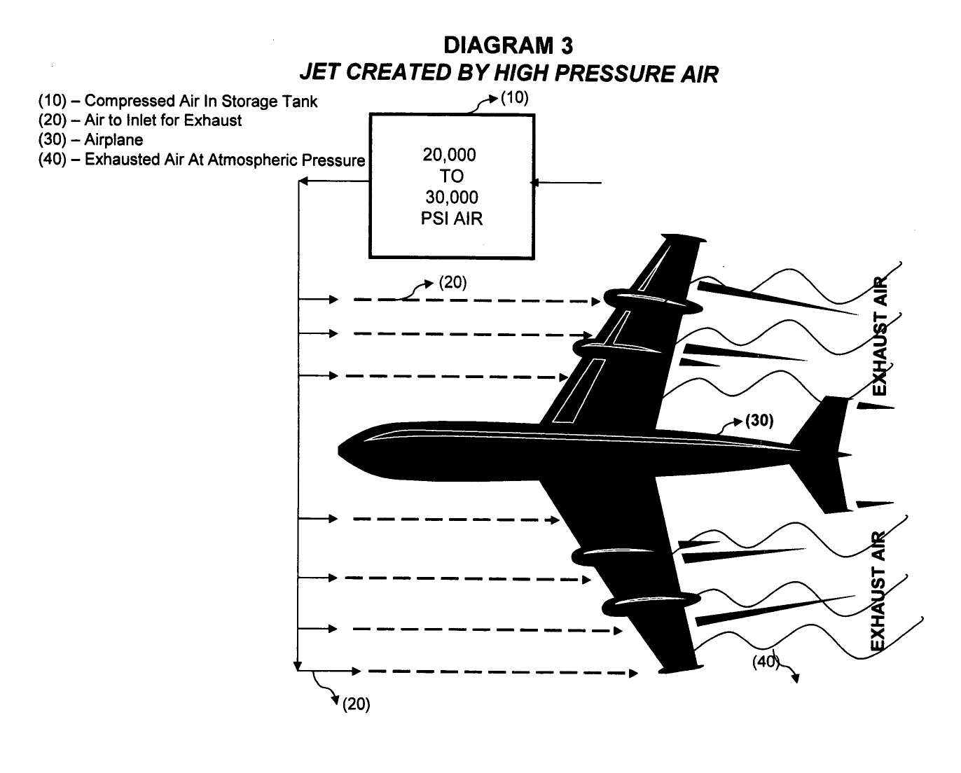

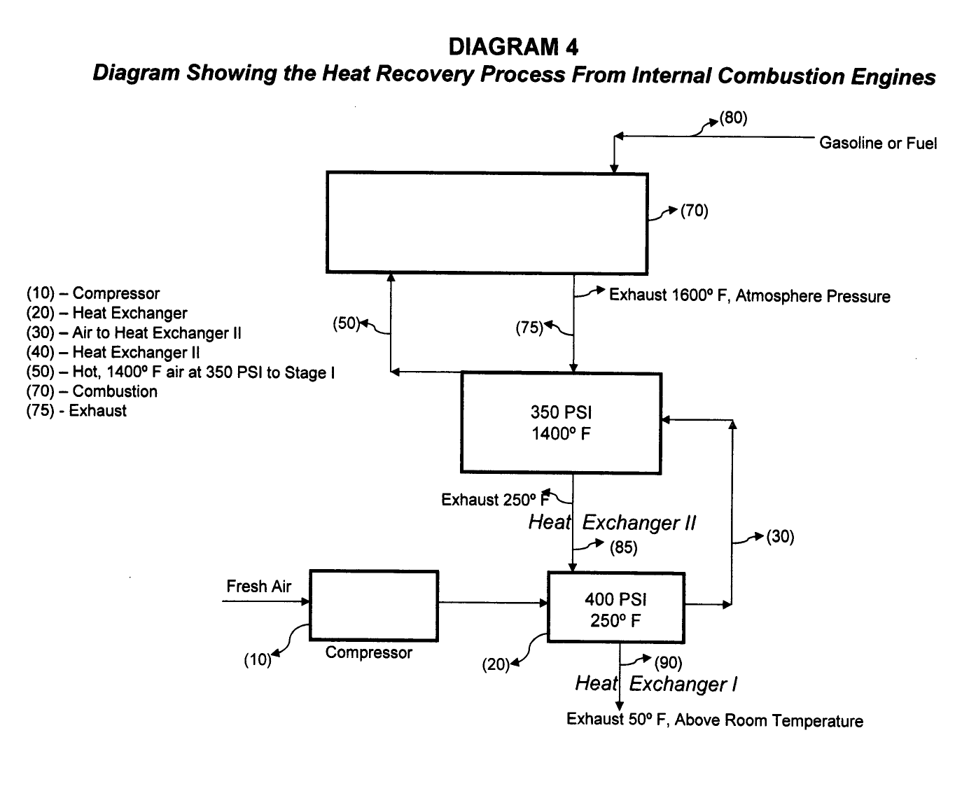

Fresh air for combustion is heated to about 1400 degrees Fahrenheit. According to Thermodynamic Laws, by heating the air in a closed space with constant volume at room temperature to 1600 degrees F., the pressure is increased about to 50 psi. In order to have a higher pressure, the fresh air is first compressed upto 100 psi before passing through a heat exchanger. This will give the available working pressure of about 350 psi before injuction into the cylinders. Initially compressed, hot air is used to drive a set of cylinders. The high pressure hot air for combustion is released above 120 psi to burn in presence of fuel to drive the engine. Since the recovery of heat the efficiency is increased, An average car will give upto 4 times more mileage and hybrid cars will give 6 times more mileage between 100 and 200 miles per gallon.

This method can be applied to all types of Internal Combustion Engines, including but not limited to Automobiles, Trucks, Airplanes, Power Plants, Motor cycles, Lawn Mowers, heavy Equipments, locomotives etc.

### REFERENCES

NONE

### BACKGROUND AND SUMMARY OF INVENTION

In evaluating this process, the basic laws of Thermodynamics were evaluated. The efficiency of most internal combustion engines is between 20% to 30%. This is because of the fact that heat generated by combustion is used partially in the form of work and the balance Is lost to the atmosphere, through exhaust gases and radiator. In order to improve the efficiency of the internal combustion engine in this method, most of the heat recovered and converted back Into work, thereby increasing the overall efficiency upto 95%.

In automobiles, or other Internal combustion engines, when gasoline or other fuel is burned pressure is generated because of the expansion and conversion of liquid into gases as well as increase in the temperature. Before combustion, in the present method, the fuel and air are at room temperature. After combustion, the temperature of gases increases to over 1600 F. This temperature increases the pressure about 3.5 times. Formation of Carbon-di-Oxide and water in vapor phase increases overall pressure to about 180 psi in the cylinders, that drives the engine.

Therefore, there are two effects in the process (i) Conversion of liquid fuel into gases that Generates a pressure of about 50 psi due to combustion and (ii) Increase of temperature that increases the pressure about 3.5 times, generating a total pressure of about 180 psi in automobiles. This pressure drives the engine in the form of work.

In the present method, the heat generated after release of exhaust gases is lost to the atmosphere, by circulation of anti-freeze through a radiator, thereby reducing the effeciency of the engine.

In this new invention, heat is recovered by passing the hot exhaust gases through a Heat exchanger. One side hot exhaust gases are passed to recover the heat and other side fresh cold air at room temperature is passed to heat it before combustion. The exhaust gases will be removed about 40 to 50 degrees above atmospheric temperature.

The process consists of two stage compression/heating for fresh air and just cooling for exhaust air. In the first stage outside combustion air is compressed to upto 100 psi by a compressor, while being heated by the exhaust air. In the second stage, this air at 100 psi being run through a heat exchanger to heat to about 1400 degrees F., thereby increasing the pressure of fresh air to about 350 psi.

The high pressure (350 psi) and hot (1400 F.) air first passed through a set of cylinders with no fuel, to drive the cylinders and released around 120 psi to another set of cylinders where Fuel (gasoline, diesel, oil or natural gas) is introduced for combustion. As the air is already hot and pressurized only a very small fraction of fuel is required to increase the pressure to around 180 psi before releasing at atmospheric pressure to heat exchangers, for recovery of heat from exhaust gases.

This being a duel process, where in first set of cylinders no fuel is used as the fresh air is under very high pressure and temperature. Here work done by the cylinders to drive the Internal combustion engine by recovery of heat from the exhaust. An additional set of Batteries can be used to run the compressor. Therefore first set of pistons or cylinders run with no fuel and second set of cylinders or pistons run with a small amount of fuel. Because of increase in efficiency of the internal combustion engine the mileage can be Increased significantly.

### PRIOR ART

In present method, fuel is burned inside cylinder where fuel and air at room temperature Introduced for combustion at room temperature and atmospheric pressure. After the fuel is burned, the combustion products are discharged at atmospheric pressure and high temperature. Heat is recovered from the engine to keep it cool as large amount of fuel is burned. The efficiency of the engines is between 20% to 30%.

New electric engines are being used in automotives that run on the batteries. These type of engines have limitations of speed and can drive 40 to 50 miles before the batteries require charging.

### DRAWINGS

Diagram 1: Diagram showing the heat recovery process from internal combustion engines.

Diagram 2: Diagram showing engines driven with no fuel such as gasoline.

Diagram 3: Diagram showing jets created by high pressure air.

### SUMMARY OF PRESENT INVENTION

The First Law of Thermodynamics states that energy is conserved, although it can be altered into form such as heat into work or electricity and transferred from one plane to another, the total quantity remains constant. The First Law expressed mathematically as:

dU=dQ−dW
where dU represents a differential change in energy U
dW represents the energy exchanges between the system and surroundings
where W is the work done by or on the system.

In Internal combustion engines, energy is converted into work to drive an automobile, a Truck, jet engines etc. Since only part of the heat is converted into work the efficiency of these engines is very low. Most of the heat is lost to the atmosphere. In this invention, recovery of heat from the exhaust gases to convert back into work will Increase efficiency of the engines to as high as 95%.

When gasoline, diesel or any other fuel is burned in an internal combustion engine, the increase in pressure takes place via two methods: (i) conversion fuel into gaseous products and (ii) increase in temperature due of the energy generated because of combustion of fuel.

As we know from the following Law

PV=nRT or

(P1V1)/T1=(P2V2)/T2

From the above laws we find that by increasing the temperature of the fresh air for combustion, the pressure is increased 3.5 to 4 times if in a closed constant volume.

In this method first the air is compressed upto 500 psi by a compressor(10). The second compressor will push the fresh air into a constant volume heat exchanger where the air Is heated by the exhaust gases. The exhaust gases are at atmospheric pressure. In both stages, the exhaust gases are passed through a heat exchanger to recover heat. In first stage(20) the temperature of exhaust gases entering to the heat exchanger will be about 250 F and and leaving to atmosphere about 50 F above outside temperature. In second stage(40), the temperature of exhaust gases entering will be about 1600 F and they will exit to exchanger one at around 250 F. These two heat exchangers will recover most of heat from the exhaust gases. As the temperature in exchanger 2 increases to about 1400 degrees F., the pressure in the heat exchanger increases to about 350 psi. At this pressure and temperature, fresh air is introduced(50) to the internal combustion engine(60) without any fuel. A set of cylinders or Pistons will operate at this point, while discharging to another set(70) around 150 psi and a small amount of fuel is burned to increase the pressure to around 180 psi. The flue gases will be discharged at atmospheric pressure to the heat exchangers(40,20) for recovery of heat. This recovered heat is converted back to work and the process continues.

Advantages of this Method are as Follows:

(i) Because of the heat recovery and compression the efficiency of the Internal combustion engines can be increased from less than 30% to upto 95% resulting in higher mileage

(ii) Radiators used for cooling using Anti-freeze(Ethylene Glycol) can be eliminated.

(iii) Combustion of fuel can be 100% with no emissions, so catalytic convertor is eliminated.

(iv) Vehicle mileage increased almost four times.

(v) Using hybrid engine, a typical automobile can achieve 150 to 200 miles per gallon.

(vi) Amount of carbon-di-oxide produced is minimum.

Alternate Method:

In this method, only high pressure air(105) is used and no fuel to drive the engine. High pressure above 500 psi can be used to drive an engine(110). Two set of batteries are used in this process. First set of batteries drive compressors while the second set is getting charged. This method eliminates total gasoline usage.

Apart from gasoline and other vehicles that are used on the ground, this method is highly recommended for aeroplanes, where jet action can be produced by the high pressure air(10). Compressed air at 15,000 to 20,000 psi is used to produce same effect that is produced by today's jet engines. Another advantage is that while descending no air is required and in case of emergencies power is readily available instantly.

The amount of air required for the jet effect can be calculated by following Jatkar equation:

Air required=(v) per minute
where v is typical volume of airplane

For initial take off the value of e+2 can be used, and lower values after attending the altitude.

Advantages:

(i) No jet engine is required or any fuel.

(ii) Only compressors are used. Required amount is compressed at any time. No need to carry load of fuel. Any speeds can be achieved depending pressure and amount of jet.

I claim:

1. Use of heat recovery by preheating/pressurizing the fresh air for combustion in Internal combustion engines used in cars using gasoline, diesel, natural gas or any fuel.

2. Use of heat recovery by preheating/pressurizing the fresh air for combustion in Internal combustion engines used in trucks using gasoline, diesel, natural gas or any fuel.

3. Use of heat recovery by preheating/pressurizing the fresh air for combustion in Internal combustion engines used in heavy equipment using diesel or any fuel.

4. Use of heat recovery by preheating/pressurizing fresh air for combustion in Internal combustion engines used in airplanes (jet or propeller) using any fuel.

5. Use of heat recovery by preheating/pressurizing fresh air for combustion in Internal combustion engines used in production of electricity using any fuel.

6. Use of heat recovery by preheating/pressurizing fresh air for combustion in Internal combustion engines used in lawn-mowers, motorcycles etc. using gasoline, Diesel or any other fuel.
